(19) United States
(12) Patent Application Publication
(10) Pub. No.: US 2025/0088431 A1
(43) Pub. Date: Mar. 13, 2025

(54) METHOD AND APPARATUS FOR DISTRIBUTED INFERENCE

(71) Applicant: Huawei Technologies Co., Ltd., Shenzhen (CN)

(72) Inventors: Huazi Zhang, Kanata (CA); Yiqun Ge, Kanata (CA); Wen Tong, Ottawa (CA)

(21) Appl. No.: 18/901,713

(22) Filed: Sep. 30, 2024

Related U.S. Application Data
(63) Continuation of application No. PCT/CN2022/085490, filed on Apr. 7, 2022.

(51) Int. Cl. H04L 41/16; H04W 24/02

(52) U.S. Cl. CPC H04L 41/16; H04W 24/02

(57) ABSTRACT

Aspects of the present disclosure relate to inference and, in particular, to distributed inference representative of a machine learning process. It is expected that inferencing will be a service in wireless networks. Aspects of the present application relate to applying aspects of coding theory to distributed inference to introduce redundancy. Methods of decoding outputs from a distributed inference process are also provided.

### CROSS-REFERENCE TO RELATED APPLICATION

This application is a continuation of International Application No. PCT/CN2022/085490, filed on Apr. 7, 2022, the disclosure of which is hereby incorporated by reference in its entirety.

### TECHNICAL FIELD

This application relates to inference and, in particular, to distributed inference representative of a machine learning process.

### BACKGROUND

Wireless communication systems of the future, such as sixth generation or “6G” wireless communications, are expected to trend towards ever-diversified application scenarios. It is expected that many applications will use artificial intelligence (AI), such as machine-learning (ML), to provide services for large numbers of devices.

One common application of machine learning is performing inference to extract insights from data. In the context of wireless communication networks, a machine learning process, such as a deep neural network (DNN), may be trained to perform inference using data from devices in the network. The machine learning process may be deployed in, for example, a data center which is remote from the devices providing the data, which means that large amounts of data may need to be transferred over the network from the devices to the machine learning process. As wireless connections may not provide sufficient bandwidth and stability to transfer data to the machine learning process, this data transfer may only be feasible when the devices are connected to the network by wired or optical fiber connections which can provide wideband and stable connections.

However, this risks significantly limiting the use cases for which machine learning may be applied. Many devices are connected to networks by wireless links, which can be unreliable and have high latency. This issue can be particularly acute for wireless links in Internet of Things (IoT) networks. As such, it can be particularly challenging for machine learning services to provide data to or use data from IoT devices in wireless networks.

### SUMMARY

Systems and methods are provided that facilitate distributing an inference job to multiple devices, such that each device performs one or more tasks as part of the machine learning process. This can alleviate the computational load of each device compared to a situation where one device performs the entire inference job, whilst also reducing the amount of data that each device may need to communicate as part of the machine learning process (e.g., reducing the traffic load). Since the computation and traffic load of each device is decreased, lower-complexity devices, such as IoT devices, may be used to perform inference. This means that inference can be performed using low-cost hardware that may even be battery powered.

By distributing the machine learning process across multiple devices in this manner, inference can be performed closer to the data source (e.g., closer to the client devices providing the data for inference). For example, the machine learning process may be implemented by multiple devices (such as client devices) in the access network or the core network.

However, since the devices performing inference may be low-cost and/or low power devices, the processing and transmission capabilities of the devices may be limited. This means that an inference task performed by a particular device may be likely fail due to computation and/or transmission errors, which may affect the performance of the overall inference process.

Aspects of the present disclosure relate to a distributed inference process representative of a machine learning process. Redundancy is introduced into the distributed inference process by encoding a plurality of inputs for the distributed inference process to generate one or more redundant inputs. The plurality of inputs and the one or more redundant inputs are input to a same component inference process as part of the distributed inference process. This approach to generating the redundant inputs is invariant of the machine learning process, which means that the same component inference process can be implemented at each of the apparatus involved in the distributed inference process. Thus, for example, the same component inference process trained using the same machine learning method and training data may be implemented at each of the respective processing apparatus, which is a significant practical advantage over conventional coded inference methods that employ a specially-trained redundant inference unit.

In one aspect, a method is provided. The method comprises obtaining a plurality of inputs for a distributed inference process representative of a machine learning process, in which each of the plurality of inputs is for a same component inference process of the distributed inference process. The method further comprises encoding the plurality of inputs to generate one or more redundant inputs such that each of the one or more redundant inputs comprises a concatenation of data from a respective at least two of the plurality of inputs. Each of the one or more redundant inputs is for the same component inference process of the distributed inference process. The method further comprises transmitting, for each of the plurality of the inputs and each of the one or more redundant inputs, the respective input to a respective processing apparatus for performing the same component inference process as part of the distributed inference process.

In a further aspect, transmitting the respective input to the respective processing apparatus may comprise transmitting the respective input to the respective processing apparatus over a wireless communication link.

In a further aspect, the method may further comprise, for each of the one or more redundant inputs, resizing the respective redundant input such that the respective redundant input has a same dimension as at least one of the plurality of inputs.

The resizing may comprise at least one of: cropping, downsampling, interpolation or padding.

In a further aspect, the plurality of inputs may form an ordered dataset and, for each of the one or more redundant inputs, the respective at least two of the plurality of inputs may be adjacent in the ordered dataset.

In a further aspect, the machine learning process comprises a deep neural network.

In another aspect, a method is provided. The method comprises obtaining a plurality of outputs of a distributed inference process representative of a machine learning regression process. The plurality of outputs comprising a plurality of results and a plurality of redundant results. Each of the plurality of results is determined by a same component inference process of the distributed inference process based on a respective input in a plurality of inputs. Each of the one or more redundant results is determined by the same component inference process of the distributed inference process based on a respective redundant input comprising a concatenation of data from a respective at least two of the plurality of inputs. The method further comprises performing one or more linear operations on at least two results to decode the plurality of outputs to obtain inference data. The at least two results are from the plurality of results and the one or more redundant results, and the at least two results comprise at least one of the one or more redundant results.

In a further aspect, performing the one or more linear operations to decode the plurality of outputs to obtain inference data may comprise performing the one or more linear operations to determine a missing output from the inference process.

In a further aspect, the inference process may be further representative of a machine learning classification process. The plurality of outputs may further comprise a plurality of labels and one or more redundant labels. The method may further comprise performing one or more set operations on at least two labels to decode the plurality of outputs to the obtain inference data. The at least two labels may comprise at least one of the one or more redundant labels.

In another aspect, a method is provided. The method comprises obtaining a plurality of outputs from a distributed inference process representative of machine learning classification process. The plurality of outputs comprises a plurality of labels and one or more redundant labels. Each of the plurality of labels is determined by a same component inference process of the distributed inference process based on a respective input in a plurality of inputs. Each of the one or more redundant labels is determined by the same component inference process of the distributed inference process based on a respective redundant input comprising a concatenation of data from a respective at least two of the plurality of inputs. The method further comprises performing one or more set operations on at least two labels to decode the plurality of outputs to obtain inference data. The at least two labels are from the plurality of labels and the one or more redundant labels, and the at least two labels comprise at least one of the one or more redundant labels.

In a further aspect, performing the one or more set operations to decode the plurality of outputs to obtain inference data may comprise performing the one or more set operations to determine a missing output from the inference process.

In a further aspect, the inference process may be further representative of a machine learning regression process. The plurality of outputs may further comprise a plurality of results and one or more redundant results. The method may further comprise performing one or more linear operations on at least two results to decode the plurality of outputs to obtain the inference data. The at least two results may be from the plurality of results and the one or more redundant results, and the at least two results may comprise at least one of the one or more redundant results.

In a further aspect, performing the one or more set operations to decode the plurality of outputs to obtain inference data may comprise performing a belief propagation process to decode the plurality of outputs to obtain the inference data.

In another aspect, an apparatus configured to perform any one of the aforementioned methods is provided. In yet another aspect, a memory is provided. The memory contains instructions which, when executed by a processor, cause the processor to perform any one of the methods described above.

In another aspect, an apparatus is provided. The apparatus comprises a memory storing instructions and a processor. The processor is caused, by executing the instructions, to obtain a plurality of inputs for a distributed inference process representative of a machine learning process and encode the plurality of inputs to generate one or more redundant inputs such that each of the one or more redundant inputs comprises a concatenation of data from a respective at least two of the plurality of inputs. Each of the plurality of inputs and the one or more redundant inputs is for a same component inference process of the distributed inference process. The processor is further caused, by executing the instructions, to transmit, for each of the plurality of the inputs and each of the one or more redundant inputs, the respective input to a respective processing apparatus for performing the same component inference process as part of the distributed inference process.

In a further aspect, the processor may be further caused, by executing the instructions, to transmit the respective input to the respective processing apparatus by transmitting the respective input to the respective processing apparatus over a wireless communication link.

In a further aspect, by executing the instructions, the processor may be further caused to, for each of the one or more redundant inputs, resize the respective redundant input such that the respective redundant input has a same dimension as at least one of the plurality of inputs.

In a further aspect, the processor may be further caused to resize the respective redundant input by at least one of: cropping, downsampling, interpolation or padding the respective redundant input.

In a further aspect, the plurality of inputs may form an ordered dataset. By executing the instructions, the processor may be caused to encode the plurality of inputs by encoding the plurality of inputs to generate one or more redundant inputs such that, for each of the one or more redundant inputs, the respective at least two of the plurality of inputs may be adjacent in the ordered dataset.

In a further aspect, the machine learning process may comprise a deep neural network.

Another aspect provides an apparatus. The apparatus comprises a memory storing instructions and a processor. The processor is caused, by executing the instructions, to obtain a plurality of outputs of a distributed inference process representative of a machine learning regression process, in which the plurality of outputs comprising a plurality of results and a plurality of redundant results. The processor is further caused, by executing the instructions, to perform one or more linear operations on at least two results to decode the plurality of outputs to obtain inference data. Each of the plurality of results is determined by a same component inference process of the distributed inference process based on a respective input in a plurality of inputs. Each of the one or more redundant results is determined by the same component inference process of the distributed inference process based on a respective redundant input comprising a concatenation of data from a respective at least two of the plurality of inputs. The at least two results are from the plurality of results and the one or more redundant results, and the at least two results comprise at least one of the one or more redundant results.

In a further aspect, the processor may be further caused, by executing the instructions, to perform the one or more linear operations to determine a missing output from the inference process.

In a further aspect, the inference process may be further representative of a machine learning classification process. The plurality of outputs may further comprise a plurality of labels and one or more redundant labels. The processor may be further caused, by executing the instructions, to perform one or more set operations on at least two labels to decode the plurality of outputs to the obtain inference data. The at least two labels may be from the plurality of labels and the one or more redundant labels, and the at least two labels may comprise at least one of the one or more redundant labels.

Another aspect provides an apparatus. The apparatus comprises a memory storing instructions and a processor. The processor is caused, by executing the instructions, to obtain a plurality of outputs from a distributed inference process representative of machine learning classification process. The plurality of outputs comprises a plurality of labels and one or more redundant labels. The processor is further caused, by executing the instructions, to perform one or more set operations on at least two labels to decode the plurality of outputs to obtain inference data. Each of the plurality of labels is determined by a same component inference process of the distributed inference process based on a respective input in a plurality of inputs. Each of the one or more redundant labels is determined by the same component inference process of the distributed inference process based on a respective redundant input comprising a concatenation of data from a respective at least two of the plurality of inputs. The at least two labels are from the plurality of labels and the one or more redundant labels, and the at least two labels comprise at least one of the one or more redundant labels.

In a further aspect, the processor may be further caused, by executing the instructions, to perform the one or more set operations to determine a missing output from the inference process.

In a further aspect, the inference process may be further representative of a machine learning regression process. The plurality of outputs may further comprise a plurality of results and one or more redundant results. The processor may be further caused, by executing the instructions, to perform one or more linear operations on at least two results to decode the plurality of outputs to obtain the inference data. The at least two results may be from the plurality of results and the one or more redundant results, and the at least two results may comprise at least one of the one or more redundant results.

In a further aspect, the processor may be further caused, by executing the instructions, to perform the one or more set operations to decode the plurality of outputs to obtain the inference data by performing a belief propagation process to decode the plurality of outputs to obtain the inference data.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 is a schematic diagram of a communication system in which embodiments of the disclosure may occur;

FIG. 2 is another schematic diagram of a communication system in which embodiments of the disclosure may occur;

FIG. 3 is a block diagram illustrating units or modules in devices in which embodiments of the disclosure may occur;

FIG. 4 is a block diagram illustrating units or modules in a device in which embodiments of the disclosure may occur;

FIG. 5 shows an exemplary way of combining input images to form a redundant input image according to an embodiment of the disclosure;

FIG. 6 shows an example of system for implementing a coded inference process;

FIG. 7 is a flowchart of a method according to embodiments of the disclosure;

FIG. 8 is a flowchart of a method according to embodiments of the disclosure;

FIG. 9 shows an example of input images and a redundant image according to embodiments of the disclosure;

FIG. 10 shows an example of a distributed inference process according to embodiments of the disclosure; and

FIGS. 11 and 12 show object detection rates for distributed inference processes performed according to embodiments of the disclosure.

### DETAILED DESCRIPTION OF THE EMBODIMENTS

The operation of the current example embodiments and the structure thereof are discussed in detail below. It should be appreciated, however, that the present disclosure provides many applicable inventive concepts that can be embodied in any of a wide variety of specific contexts. The specific embodiments discussed are merely illustrative of specific structures of the disclosure and ways to operate the disclosure, and do not limit the scope of the present disclosure.

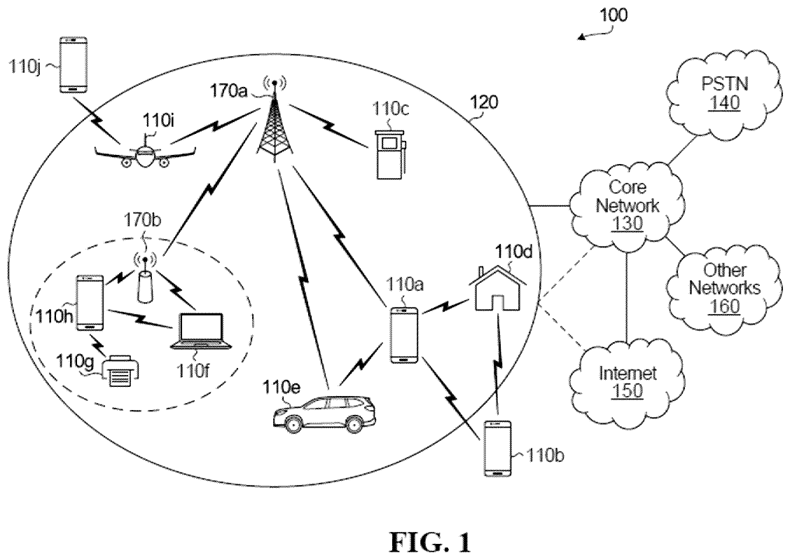

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

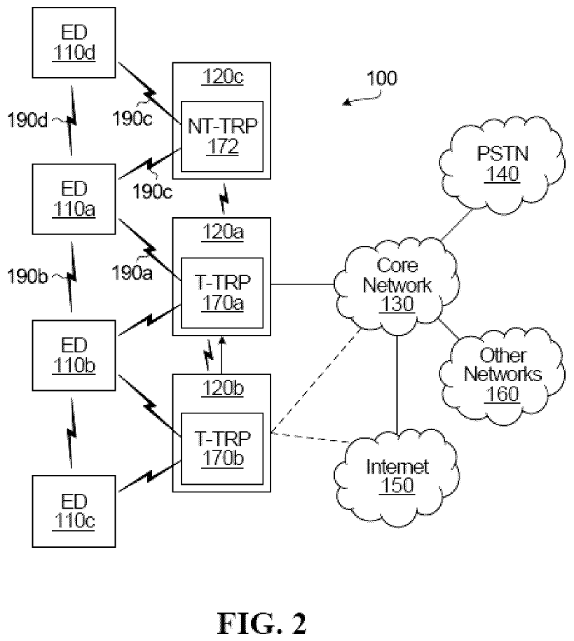

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

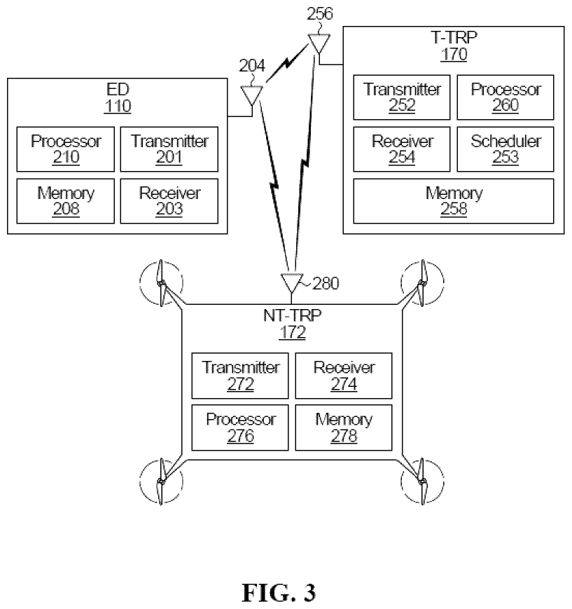

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP)), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

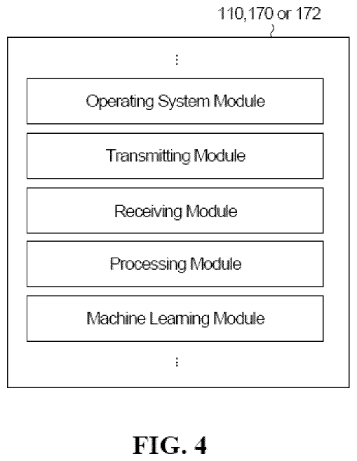

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

In situations in which a centralized machine learning process, such as a centralized DNN, performs inference using data from a distributed set of devices, the reliability of the machine learning process may be dependent on the quality, reliability, and latency of transmissions between the machine learning process and the devices.

This may be illustrated by considering an example in which a machine learning process is deployed in a remote data center which is connected to a core network of a communications network. The communications network comprises a plurality of devices which are connected to the core network via TRPs, or base stations, in an access network. The machine learning process, at the remote data center, is operable to receive inference requests from the core network, in which the requests comprise data from the plurality of client devices.

However, disruptions to, for example, wireless connections between the client devices and their respective TRPs may cause packet loss or delays in the reception of data from the client devices at the remote data center. Even if a client device has a stable connection to the network, the network path between the client device and the remote data center may be long and/or may include many hops, increasing the risk of delay and packet loss. In addition, congestion in the network due to, for example, transmission of large data such as image or video data may further reduce the reliability of transmissions between the devices, the core network, and the remote data center.

As such, the inference performance of the machine learning process may be hampered by the quality, reliability, and latency of transmissions between the devices, the core network, and the remote data center.

These issues can be mitigated by performing inference locally to data sources. Thus, for example, the machine learning process could be deployed closer to the devices. However, machine learning processes can be computationally intensive. A DNN, for example, may have as many as 10-100 billion neurons. As such, it may be challenging to deploy performing inference using a machine learning process on a single client device.

Instead, a machine learning process can be implemented using low-cost and low-power apparatus by distributing the machine learning process across a plurality of apparatus. In the context of wireless communication networks, distributed inference may be particularly advantageous since input data for inference processes is often collected by apparatus in access networks, such as electronic communication devices and TRPs. By distributing machine learning processing across a plurality of apparatus, the machine learning process can be implemented in or near to the access network, reducing the risk of input data for the machine learning process being lost or delayed.

However, when a machine learning process is distributed across multiple apparatus, there is a risk of an apparatus not returning its result due to, for example, an error in computation or transmission. This risk can be mitigated by introducing redundancy such that a missing result can be recovered.

Coded inference has been proposed as a way to introduce this redundancy. However, existing approaches to introducing interference redundancy involve the use of a redundant interference unit, and result in a significant increase both in the training and inference complexity of the redundant inference unit 606. Moreover, some proposed approaches involve the use of a parity model to generate redundant inputs, and it can be more difficult to learn a parity model as features from more queries are packed into a single parity query.

Aspects of the present disclosure provide a method which includes obtaining a plurality of inputs for a distributed inference process representative of a machine learning process. Each of the plurality of inputs is for a same component inference process of the distributed machine learning process. The method further includes encoding the plurality of inputs to generate one or more redundant inputs such that each of the one or more redundant inputs comprises a concatenation of data from a respective at least two of the plurality of inputs. Each of the one or more redundant inputs are for the same component inference process of the distributed inference process. The method further comprises transmitting, for each of the plurality of inputs and each of the one or more redundant inputs, the respective input to a respective processing apparatus for performing the same component inference process as part of the distributed inference process.

Thus, according to the aspects of the present disclosure, a redundant input for a distributed inference process may be generated by concatenating (e.g., joining without mixing) data from two or more of the plurality of inputs. This process may be referred to as encoding, analogous to coding theory. As such, the redundant input may be generated by, or according to, a code which indicates the data used to form the redundant input and how the data is joined (e.g., in what order) to form the redundant input. Thus, a code may be applied to the plurality of inputs such that data from two or more of the plurality of inputs are concatenated to form the redundant input.

This approach to generating the redundant inputs is invariant of the machine learning process, which means that the same component inference process can be implemented at each of the apparatus involved in the distributed inference process. Thus, for example, the same component inference process trained using the same machine learning method and training data may be implemented at each of the respective processing apparatus, which is a significant practical advantage over conventional coded inference methods that employ a specially-trained redundant inference unit. Since the same inference process is deployed on each of the processing apparatus, the redundant input to the same process should induce a redundant output that contains elements of the outputs of the component inference at other apparatus. This holds with high probability because each of the apparatus uses the same process.

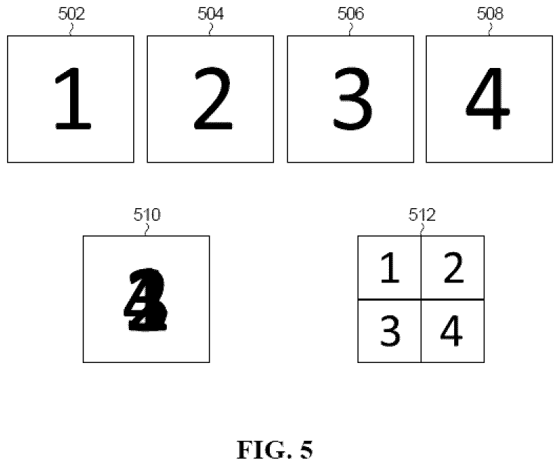

This approach may be illustrated by considering FIG. 5, which shows four input images 502, 504, 506, 508 for a number detection process developed using machine learning. The number detection process is configured to process an image with distinguishable numbers in it, such as the inputs 502, 504, 506 and 508. Given the input images 502, 504, 506 and 508, one way to combine the input images to form a redundant input image is to overlay or superpose the images to form image 510. However, the numbers in image 510 are no longer distinguishable, which means that the number detection process may not be able to detect the numbers in image 510. Thus, the number detection process may need further training to be able to process image 510.

Instead, in accordance with the present disclosure, the input images 502, 504, 506, 508 may be concatenated together to, for example, form the image 512. By joining the images 502, 504, 506, 508 together without mixing (e.g., superposing) them, the numbers are still distinguishable in the combined image 512, which means that the number detection process can still detect the numbers in image 512. This means that the same number detection process that is used for processing images 502, 504, 506, 508 can be used, without further modification, to process image 512.

Whilst this example refers to image data, the person skilled in the art will appreciate that the disclosures herein may, in general, be applied to any data which may be used for inference.

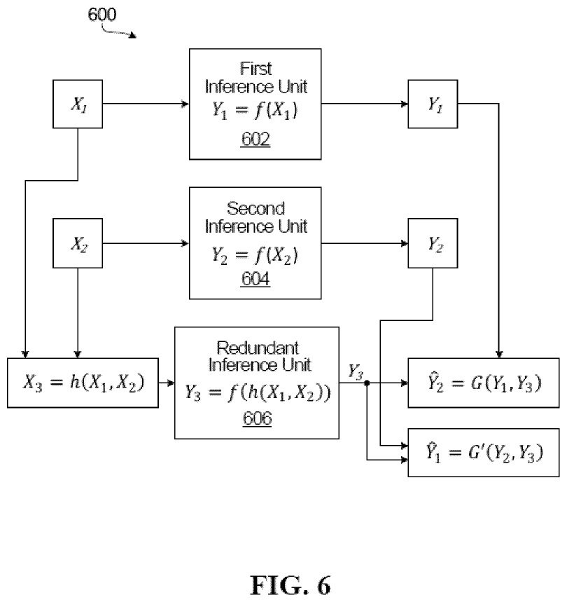

FIG. 6 shows an example of system 600 for implementing a distributed inference process in accordance with aspects of the disclosure. The system 600 comprises a first inference unit 602 and a second inference unit 604. The first inference unit 602 is operable to perform a component inference process on first input X₁ as part of the distributed inference process to obtain a first result Y₁=f (X₁). The second inference unit 604 is operable to perform the same component inference process on a second input X₂ to obtain a second result Y₂=f (X₂) as part of the distributed inference process.

The system 600 further comprises a redundant inference unit 606, which is operable to receive a redundant input X₃=h (X₁,X₂) obtained by encoding the first and second inputs. According to an aspect of the present disclosure, the first input X₁ and the second input X₂ may be encoded to generate the third input X₃ such that the third input X₃ comprises a concatenation of data from the first input X₁ and the second input X₂.

By generating the third input X₃ in this manner, the third input X₃ will still be recognizable to the component inference process implemented at first inference unit 602 and the second inference unit 604. This means that the same component inference process implemented at the first and second inference units 602, 604 can also be implemented at the redundant inference unit 606. For example, an off-the-shelf machine learning process may be implemented on each of the first, second and redundant inference units 602, 604, 606 in order to perform distributed inference with redundancy. More generally, it means that redundancy can be introduced into distributed interference without necessitating specialized training of the redundant inference unit 606.

The redundant inference unit 606 is operable to perform the component inference process on the redundant input in order to output a third result, Y₃=f (h (X₁,X₂)) which can be used to recover one of the first or second results.

Thus, for example, if the first inference unit 602 fails to return the first result, an estimate of the first result Y₁ can be determined based on the second result Y₂ (from the second inference unit 604) and the third result Y₃ (from the redundant input 606). Similarly, if the second inference unit 604 fails to return the second result, an estimate of the second result Y₂ can be determined based on the first result Y₁ (from the first inference unit 602) and the third result Y₃ (from the redundant input 606).

Aspects of the present disclosure thus allow for introducing redundancy into a distributed inference process without necessitating specialized training of redundant inference units.

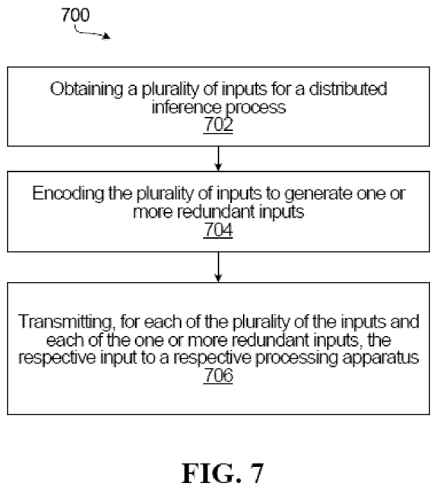

FIG. 7 shows a flowchart of a method 700 according to embodiments of the disclosure.

The method 700 may be performed by an apparatus. In particular examples, the method 700 may be performed by an apparatus in a communications system such as, for example, the communications system 100 described above in respect of FIGS. 1-4. For example, the method 700 may be performed by an apparatus in a core network (e.g., the core network 130 described above in respect of FIGS. 1-4) of a communications system. In another example, the method 700 may be performed by an apparatus in an access network (e.g., either of the RANs 120a, 120b described above in respect of FIGS. 1-4) of a communications system.

In step 702, a plurality of inputs for a distributed inference process representative of a machine learning process (e.g., algorithm) is obtained.

The distributed inference process is distributed across a plurality of processing apparatus. The processing apparatus may comprise any suitable apparatus, such as, for example, one or more communication electronic devices (e.g., any of the communication EDs 110a-110j described above in respect of FIGS. 1-4) and/or one or more network nodes (such as any of the network nodes 170a, 170b, 172 described above in respect of FIGS. 1-4). Thus, for example, the processing apparatus may, for example, be connected to a communications system by an access network (e.g., the RANs 120a, 120b described above in respect of FIGS. 1-4). In particular embodiments, the processing apparatus may be deployed in a core network (e.g., the core network 130 described above in respect of FIGS. 1-4) of a communications system.

In particular examples, the plurality of processing apparatus may comprise one or more Internet of Things (IoT) apparatus. The processing apparatus may, for example, comprise apparatus configured to perform machine-to-machine (M2M) communications.

The inputs may comprise any data on which inference may be performed. Thus, for example, the inputs may comprise one or more of: image data, audio data, video data, measurement data, network data for a communications network (e.g., indicative of traffic, usage, performance or any other network parameter), user data or any suitable data.

The plurality of inputs may be comprised in a single dataset. For example, step 702 may comprise obtaining (e.g., receiving) a single dataset comprising the plurality of inputs. Step 702 may further comprise extracting the plurality of inputs from the single dataset (e.g., by splitting or dividing the single dataset). In another example, step 702 may comprise receiving the plurality of inputs from one or more apparatus.

Each of the plurality of inputs is for a same component inference process of the distributed inference process. The component inference process may be any suitable process (e.g., algorithm) comprising one or more tasks to be performed as part of the distributed inference process. The component inference process may comprise any suitable machine learning process such as, for example, a neural network (e.g., a deep neural network, DNN), a k-nearest neighbors process, a linear regression process, a support-vector machine or any other suitable machine learning process. The component inference process may comprise, for example, a regression process, a classification process (e.g., a classifier) or a combination of a regression process and a classification process. The person skilled in the art will appreciate that the choice of machine learning process is often specific to the inference task. For example, the inference task may comprise image classification, and the component process may comprise a neural network, such as deep neural network, trained to classify images.

The same component inference process is implemented at each of the plurality of processing apparatus. In this context, the reference to the component inference process being the same means that the component inference process implemented at each of the processing apparatus comprises the same architecture and has been trained in the same way (e.g., using the same training data). As such, the same code may be implemented at each of the processing apparatus which, when executed, causes the same component inference process to be performed by the respective processing apparatus. This may equivalently be referred to as respective instances of the same component inference process being deployed at each of the processing apparatus.

In step 704, the method comprises encoding the plurality of inputs to generate one or more redundant inputs. The one or more redundant inputs are redundant to the extent that they comprise data which is also contained in the plurality of inputs for input to the component process. As such, the one or more redundant inputs may be used to recover a missing output from the distributed inference process, for example.

The plurality of inputs is processed such that each of the one or more redundant inputs comprises a concatenation of data from at least two of the plurality of inputs. This processing may be referred to as encoding since it provides redundancy in a manner analogous to coding theory. In this context, concatenation may refer to joining data from at least two of the plurality of inputs without mixing data from different inputs. Thus, for example, data from at least two of the plurality of inputs may be combined into a common dataset without superposition (e.g., addition) of data from different inputs. For example, data from at least two of the plurality of inputs may be placed side by side in the same dataset. Data from one input may be appended to another, for example. In a further example, data from, for example, three or more datasets may be tiled. Tiling may be particularly appropriate for data having two or more dimensions.

The skilled person will appreciate that there are various codes (e.g., error correcting codes) which may be used to generate the one or more redundant inputs. The code indicates which inputs are used to form the redundant input and how the inputs are joined to form the redundant output. The code may, in general, be a systematic code such that each redundant input contains the data from each of the respective two or more inputs. For example, a redundant input may comprise only data from each of the two or more inputs indicated by the code.

A code may be represented by its generator matrix, a parity check matrix or a code graph. Thus, for example, the generator matrix for a (7,4) Hamming matrix with t=1 may be written as

$$G = ( \begin{matrix}1 & 0 & 0 & 0 & 1 & 1 & 1 \\ 0 & 1 & 0 & 0 & 1 & 1 & 0 \\ 0 & 0 & 1 & 0 & 1 & 0 & 1 \\ 0 & 0 & 0 & 1 & 0 & 1 & 1\end{matrix} )$$

in which each row represents one of the plurality of inputs and each column (or variable node) represents a processing apparatus. The is in each column indicate which of the inputs is used for the component inference process at a respective processing apparatus. Thus, in this example, four inputs are used to generate three redundant inputs, resulting in a total of seven inputs for the distributed inference process. The corresponding parity check matrix may be written as

$$H = ( \begin{matrix}1 & 1 & 1 & 0 & 1 & 0 & 0 \\ 1 & 1 & 0 & 1 & 0 & 1 & 0 \\ 1 & 0 & 1 & 1 & 0 & 0 & 1\end{matrix} )$$

in which each column represents a processing apparatus, and each row represents a check node connecting respective processing apparatus. In this context, t is a measure of the error correcting capability of the code. As such, by generating redundant inputs according to a code with error correcting capability t, up to t erroneous outputs can be corrected (e.g., if a processing apparatus returns an incorrect result) or up to 2t erased outputs can be corrected (e.g., if a processing apparatus fails to return a result).

In another example, the plurality of inputs may be encoded according to a (21,12) degree-2/3 code. The parity check matrix for the (21,12) degree-2/3 code may be expressed as:

$$H = ( \begin{matrix}1 & 1 & 0 & 0 & 0 & 0 & 0 & 0 & 0 & 0 & 0 & 0 & 1 & 0 & 0 & 0 & 0 & 0 & 0 & 0 & 0 \\ 0 & 0 & 1 & 1 & 0 & 0 & 0 & 0 & 0 & 0 & 0 & 0 & 0 & 1 & 0 & 0 & 0 & 0 & 0 & 0 & 0 \\ 0 & 0 & 0 & 0 & 1 & 1 & 0 & 0 & 0 & 0 & 0 & 0 & 0 & 0 & 1 & 0 & 0 & 0 & 0 & 0 & 0 \\ 0 & 0 & 0 & 0 & 0 & 0 & 1 & 1 & 0 & 0 & 0 & 0 & 0 & 0 & 0 & 1 & 0 & 0 & 0 & 0 & 0 \\ 0 & 0 & 0 & 0 & 0 & 0 & 0 & 0 & 1 & 1 & 0 & 0 & 0 & 0 & 0 & 0 & 1 & 0 & 0 & 0 & 0 \\ 0 & 0 & 0 & 0 & 0 & 0 & 0 & 0 & 0 & 0 & 1 & 1 & 0 & 0 & 0 & 0 & 0 & 1 & 0 & 0 & 0 \\ 1 & 0 & 1 & 0 & 1 & 0 & 0 & 0 & 0 & 0 & 0 & 0 & 0 & 0 & 0 & 0 & 0 & 0 & 1 & 0 & 0 \\ 0 & 0 & 0 & 0 & 0 & 0 & 1 & 0 & 1 & 0 & 1 & 0 & 0 & 0 & 0 & 0 & 0 & 0 & 0 & 1 & 0 \\ 0 & 0 & 0 & 1 & 0 & 1 & 0 & 1 & 0 & 0 & 0 & 0 & 0 & 0 & 0 & 0 & 0 & 0 & 0 & 0 & 1\end{matrix} )$$

As this code is a (21,12) code, a group of twelve inputs may be used to generate nine redundant inputs, resulting in a total of 21 inputs. As the code is degree-2/3, each of the redundant inputs generated according to the code comprises data from two or three inputs, with the number of inputs used to generate a particular redundant input determined according to a degree distribution.

Thus, the one or more redundant inputs may be generated according to any suitable code. In particular examples, the code may be determined (e.g., selected) according to a set of one or more rules (e.g., criteria or factors). Examples of rules are provided as follows.

In one example, the code may be determined such that each redundant input comprises data from only a number of inputs which satisfies a maximum threshold (e.g., is less than a maximum threshold). This may be referred to as limiting the number of degrees for each redundant input, for example. Thus, for example, the code may be selected based on its sparsity. By limiting the number of degrees for each redundant input, decoding complexity can be reduced whilst improving inference performance. In the context of image detection, sparse codes can provide improved detection rates, for example.

Additionally or alternatively, the code may be determined based on the order or adjacency of two or more inputs in the plurality of inputs. This may be particularly appropriate when the plurality of inputs form an ordered dataset (e.g., an image, audio data, video data, a time series or any other suitable ordered dataset). In these examples, the plurality of inputs may be encoded such that, for each of the one or more redundant inputs, the respective at least two of the plurality of inputs are adjacent in the ordered dataset.

Thus, in an example in which the inputs comprise component images extracted from a composite image, the plurality of inputs may be encoded such that a redundant input comprises pixels from two component images that are adjacent in the composite image. In another example in which the inputs comprise frames extracted from video data, the plurality of inputs may be encoded such that a redundant input comprises data from two subsequent frames in the video data. Maintaining adjacency of data in the redundant input may increase the probability that meaningful inference can be performed on the redundant input.

The code may be further determined based on its degree distribution. In this context, degree indicates the number of connections associated with an input (e.g., one of the plurality of inputs or a redundant input) or a constraint among inputs. Thus, for example, the degree of a particular input in the plurality of inputs may indicate the number of redundant inputs that include data from that particular input. The degree distribution of a code indicates the probability mass function of the degrees for the code. The degree distribution of the code may be optimized to improve decoding performance and/or reduce decoding complexity. The skilled person will appreciate that there are various ways in the degree distribution may be optimised. For example, a computer simulation may be used to identify an optimal degree distribution. A code may then be selected based on the computer simulation.

The skilled person will appreciate that determining the code according to one or more of the aforementioned rules may comprise determining the type of code. There are various types of codes which may be suitable for implementation in the method 700. By way of example only, suitable codes may include a Hamming code, a low-density parity-check (LDPC) code, a polar code (e.g., a systematic polar code), a Bose-Chaudhuri-Hocquenghem (BCH) code, a Reed-Muller (RM) code, a Golay code (e.g., a binary Golay code), or any other suitable code.

For example, the code may be determined to be an LDPC code based on the sparsity rule described above. LDPC codes are sparse, so an LDPC code may be selected in order to limit the number of degrees for each redundant input. Thus, the type of code may be selected based on one or more of the aforementioned rules.

Additionally or alternatively, a characteristic of the code may be determined according to one or more of the aforementioned rules. In one example, the generator matrix for a particular type of code may be determined based on the aforementioned rules. For example, the code may already be determined to be an LDPC code, and the generator matrix for the LDPC code may be determined based on a desired order or adjacency of two or more inputs in the plurality of inputs.

The skilled person will appreciate that the type of code and/or characteristics of the code may be further determined based on one or more performance constraints for the distributed inference process. For example, the code may be determined to satisfy a constraint relating to one or more of: a complexity, latency, resource availability (e.g., number of available processing apparatus) and a memory usage of the distributed inference process. In another example, the code length may be determined based on one or more performance constraints. In general, the code length should not be too long (e.g., may be have a length of less than 50).

Although examples of codes are provided herein, the skilled person will appreciate that the present disclosure is not limited as such and, in general, any suitable code may be used.

The method 700 further comprises, in step 706, transmitting, for each of the plurality of the inputs and each of the one or more redundant inputs, the respective input to a respective processing apparatus in the plurality of processing apparatus. Each respective input is transmitted to the respective processing apparatus for performing the same component inference process as part of the distributed inference process.

Thus, in the example of a (7,4) Hamming code described above, step 706 may comprise transmitting each of the 4 inputs and 3 redundant inputs to a respective processing apparatus for performing the same component inference process. As such, there may be seven instances of the component inference process, with each instance running on a different processing apparatus.

The respective inputs may be transmitted to the processing apparatus directly or indirectly. Thus, for example, the respective inputs may be transmitted to the processing apparatus via one or more intermediate apparatus. One or more of the respective inputs may be transmitted to the respective processing apparatus over a wireless link. For example, the method 700 may be performed in a communications system, such as the communications system 100 described above in respect of FIGS. 1-4, and the plurality of processing devices may be connected to the communications system by respective wireless links. Since wireless links may less reliable and have higher latency, distributed inference may be particularly vulnerable to data loss when the processing apparatus are connected by wireless links. As such, the redundancy provided by the method 700 may be particularly advantageous when the processing apparatus are connected by wireless links.

The method 700 may further comprise resizing the redundant inputs such that each redundant input has a same or comparable dimension as at least one of the plurality of inputs. Since the redundant inputs are formed by concatenating data from two or more inputs, the redundant inputs may have different dimensions to the inputs. For example, a redundant input formed by tiling four images having N×N pixels may have dimensions 2N×2N. This may make it difficult for the component inference process to process the redundant input, since the component inference process may be configured to perform inference on inputs having particular dimensions. As such, the redundant inputs may be resized to enable easier processing by the processing apparatus. In particular examples, the redundant inputs may be resized to have the same dimensions as at least one of the plurality of inputs. For example, each of the redundant inputs and each of the plurality of inputs may have the same dimensions.

The skilled person will appreciate that various techniques may be used to resize the redundant inputs. Resizing may, for example, comprise reducing one or more of the dimensions of the redundant inputs by, for example, cropping (e.g., trimming) or downsampling (e.g., downscaling) the redundant inputs. Reducing the size of the redundant input may reduce memory requirements for the processing apparatus. Resizing may, additionally or alternatively, comprise interpolating and/or padding the redundant inputs. For example, a redundant input formed by tiling three N×N datasets may be padded to have dimensions 2N×2N and then downscaled to have dimensions N×N.

Resizing may be performed at the same apparatus that performs the encoding. Alternatively, resizing may be performed elsewhere. For example, the redundant inputs may be transmitted to respective processing apparatus and each respective processing apparatus may resize the received redundant input in accordance with any of the techniques described above.

The skilled person will appreciate that inference is often performed on large datasets. In some embodiments, the plurality of inputs referred to in the aforementioned method 700 may comprise a subset of a dataset on which inference is to be performed. A dataset on which inference is to be performed may be divided into a plurality of groups (e.g., batches), in which each group comprises a subset of data from the dataset. Each group of data may be encoded separately such that, data from two groups is not coded together. For example, input images for a coded object detection task may be grouped into multiple batches, in which each batch contains two or more images. Each batch may comprise K input images, from which N-K redundant images are generated according to an (N,K) code. As such, images from two different batches may not be coded together.

Thus, in some embodiments, data on which inference is to be performed may be divided into groups containing a respective plurality of inputs. The method 700 may be performed in respect of each respective plurality of input. As such, data from each group may be separately encoded such that data from two different groups are not coded together. This can simplify decoding of outputs from the distributed inference process.

Embodiments of the disclosure thus provide a method of encoding inputs for a distributed inference process to generate one or more redundant inputs. By generating the one or more redundant inputs in accordance with the method 700 described above, the redundant inputs may be invariant of the machine learning process, which means that the that the same component inference process can be implemented at each of the processing apparatus involved in the distributed inference process. This means that redundancy can be provided for distributed inference processes without necessitating specialized training for processing redundant inputs.

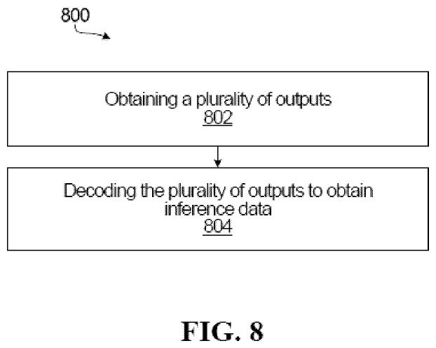

FIG. 8 shows a flowchart of a method 800 of decoding a plurality of outputs from a distributed inference process representative of a machine learning process. The distributed inference process may be the distributed inference process described above in respect of FIG. 7. The method 800 may be performed by the same apparatus that performed the method 700. Thus, for example, encoding and decoding may be performed by a same apparatus. However, the skilled person will appreciate that this need not be the case and, in general, the method 800 may be performed by any suitable apparatus.

The machine learning process may comprise a regression process. In this context, a machine learning regression process may be a process which seeks to obtain a quantity (e.g., a continuous rather than discrete result) as an inference result, in which the process has been developed using machine learning. Alternatively, the machine learning process may comprise a classification process (e.g., the machine learning process may comprise a classifier). The machine learning classification process may be any process developed using machine learning that seeks to categorize, classify or label data. The skilled person will appreciate that, in particular examples, the machine learning process may comprise both regression and classification.

In step 802, the method 800 comprises obtaining the plurality of outputs. The plurality of outputs comprises a plurality of results and a plurality of redundant results, in which each of the plurality of results is determined by a same component inference process of the distributed inference process based on a respective input in a plurality of inputs. The same component inference process may be the same component inference described above in respect of method 700, for example.

Each of the one or more redundant outputs is determined by the same component inference process of the distributed inference process based on a respective redundant input comprising a concatenation of data from a respective at least two of the plurality of inputs. The redundant inputs may be generated according to the method 700 described above in respect of FIG. 7, for example.

The plurality of outputs may be obtained by receiving, for each of the plurality of outputs, the respective output from the respective apparatus which performed the same component inference process. Thus, for example, step 802 may comprise collating the plurality of outputs from a plurality of apparatus. Alternatively, the plurality of outputs may be, for example, received from a single apparatus that collated the plurality of outputs. In general, the plurality of outputs may be received from one or more apparatus.

In examples in which the machine learning process comprises a classification process, the plurality of results may comprise a plurality of labels and the one or more redundant results may comprise one or more redundant labels. Thus, for example, each processing apparatus may output a respective label from the component inference process. Each label may indicate a class or category of a respective input. Thus, for example, a label may indicate a class or category of a feature of the respective input. For example, an image classification process may output a label indicating that one image contains a monkey and another label indicating that another image contains a bear. The labels may thus comprise for example, classes, categories, class labels or any other suitable way of categorising or classifying information.

Alternatively, in examples in which the machine learning process comprises regression and classification, the plurality of outputs may comprise a plurality of labels and one or more redundant labels in addition to the plurality of results and one or more redundant results. Thus, for example, each processing apparatus may output a respective label and a respective result from the component inference process.

In step 804, the plurality of outputs is decoded to obtain inference data. The decoding may comprise performing one or more linear operations and/or one or more set operations.

Thus, for example, step 804 may comprise performing one or more linear operations on at least two results to decode the plurality of outputs to obtain inference data. This may be particularly appropriate in examples in which the machine learning process comprises a regression process. The at least two results are from the plurality of results and the one or more redundant results, and the at least two results comprise at least one of the one or more redundant results. Therefore, the at least two results comprise at least one of the one or more redundant results, but may also comprise one or more results from the plurality of results. In other words, the at least two results comprise at least one of the one or more redundant results and zero or more of the plurality of results. Thus, for example, decoding may be performed based on two or more redundant results. Alternatively, decoding may be performed on at least one of the redundant results or one or more of the plurality of results.

The obtained inference data may comprise, for example, an estimate of a missing result from one instance of the same component inference process (e.g., a result that should have been returned by an apparatus, but was not). Since the plurality of results and the redundant results are produced using the same component inference process, the missing result can be recovered using linear operations. Even when no data is lost from the distributed inference process, decoding the results and the redundant results using linear operations can still be advantageous.

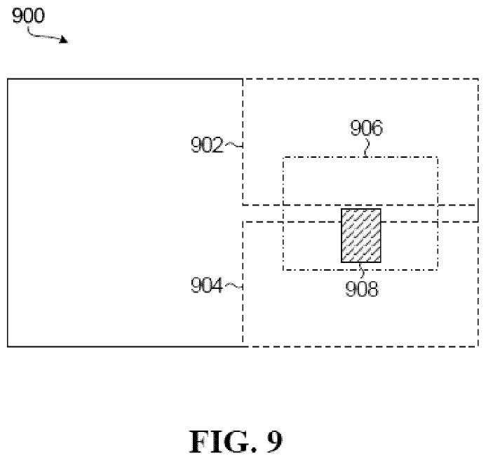

This may be illustrated by considering an example described with reference to FIG. 9. FIG. 9 shows an image 900 for processing by a distributed inference process. As part of the distributed inference process, two input images 902, 904 are extracted from the image 900. A redundant input 906 is generated comprising data from the two input images 902, 904, padded by additional data from the image 900. The position and size of a person displayed in the image 900 is represented by a bounding box 908 characterized by four quantities (x,y,w,h), in which x and y are the coordinates of the center of the rectangle, and w and h are the width and height of the rectangle.

Since the person is detected in both the second input image 904, and the redundant input image 906, the results from performing the component inference process on these images 904, 906 can be combined to obtain a more accurate result. This can be achieved by considering the positions of the input image 904 (xᵢ, yᵢ, wᵢ, hᵢ) and the redundant input image 906 (xᵣ, yᵣ, wᵣ, hᵣ) in the image 900, and the positions of the person in the input image 904 (xₚᵢ, yₚᵢ, wₚᵢ, hₚᵢ) and the redundant image 906 (xₚᵣ, yₚᵣ, wₚᵣ, hₚᵣ) returned by the component inference process. The position and size of the person in the image 900 (e.g., the position and size of the bounding box 908) can be determined according to:

$$\begin{matrix}{x}_{p} = weighted\_mean ( {x}_{i} + {w}_{i} {x}_{p i} , {x}_{r} + {w}_{r} {x}_{p r} ) \\ {y}_{p} = weighted\_mean ( {y}_{i} + {h}_{i} {y}_{p i} , {y}_{r} + {h}_{r} {y}_{p r} ) \\ {w}_{p} = weighted\_mean ( {w}_{i} {w}_{p i} , {w}_{r} {w}_{p r} ) \\ {h}_{p} = weighted\_mean ( {h}_{i} {h}_{p i} , {h}_{r} {h}_{p r} )\end{matrix}$$

The weights for the weighted means (weighted_mean) may be based on, for example, an importance or trust of each result. Each of the plurality of results and the one or more redundant results may be associated with a respective confidence indicator (e.g., a trust score) which indicates a likelihood of an entity or object existing in the bounding box. The weights for the weighted means may be based on the confidence indicators associated with the results. Thus, for example, results associated with a stronger confidence indicator (e.g., a higher likelihood of an entity or object being present) may be assigned a heavier (or larger) weight.

Thus, linear operations can be used to decode the results returned by performing a component inference process on the input image 904 and the redundant input image 906 to obtain a more accurate estimate of the position and size of the bounding box. As such, even when the distributed inference process returns results from each of instance of the component inference process (e.g., there are no missing results), the redundancy provided by the methods described herein can improve the accuracy of the inference. Even though the example discussed in respect of FIG. 9 relates to image bounding box detection, it will be appreciated that the decoding method 800 described in relation to FIG. 8 is not limited as such and may, in general, be applied to decode the outputs of any suitable distributed inference process.

Returning to the method 800, those skilled in the art will appreciate that the one or more linear operations that may be used to decode the plurality of outputs may vary depending on, for example, the outputs, the distributed inference process and/or the inference sought. In this context, a linear operation is any operation which preserves the operations of vector addition and scalar multiplication. Thus, the one or more linear operations may comprise any operation f(·) that satisfies

$$\begin{matrix}f ( x + y ) = f ( x ) + f ( y ) ; \\ f ( ax ) = a f ( x )\end{matrix}$$

for all x and y, and all constants a.

As noted above, step 804 may comprise performing one or more set operations in addition to, or instead of, the one or more linear operations.

Thus, in some examples one or more set operations may be performed in step 804 to decode the plurality of outputs to obtain inference data. The performance of one or more set operations may be particularly appropriate in examples in which the machine learning process comprises a classification process such that the plurality of outputs comprises a plurality of labels and one or more redundant labels.

As such, step 804 may comprise performing one or more set operations on at least two labels to decode the plurality of outputs to obtain inference data. The at least two labels are from the plurality of labels and the one or more redundant labels, and the at least two labels comprise at least one of the one or more redundant labels. Therefore, the at least two labels comprise at least one of the one or more redundant labels, but may also comprise one or more labels from the plurality of labels. In other words, the at least two labels comprise at least one of the one or more redundant labels and zero or more of the plurality of labels. For example, decoding may be performed based on two or more redundant labels. Alternatively, decoding may be performed on at least one of the redundant labels or one or more of the plurality of labels.

The decoding may be used to obtain a missing output (e.g., a missing label) from the distributed inference process. Additionally or alternatively, the decoding may be used to improve the accuracy of the inference process.

There are various ways in which set operations may be used to decode the plurality of outputs. In some examples, a belief propagation process (e.g., algorithm) may be used to decode the plurality of outputs. This may be illustrated by considering an example in which the redundant labels form a set R, the plurality of labels form a set S and N is the neighbor set. The plurality of outputs, i, can be decoded to obtain a plurality of inferred labels j by performing the following steps one or more times:

{class_{j→i}} = {class_{i′}, i′ ∈ N(j) ∩ R} − union({class_{i″}} for all i″ ∈ N(j) ∪ S and i″ ≠ i)
{class_{i→j}} = {classᵢ} ∪ union({class_{j′-i}} for all j′ ∈ N(i) and j′ ≠ j)
{classᵢ} = {classᵢ} ∪ union({class_{j′-i}} for all j′ ∈ N(i))

in which U denotes a union of two classes and “union” denotes union of more than two classes, “−” denotes set difference, and n denotes set intersection. The Neighbor set, N, for a particular inferred label j may comprise each out of the labels used to infer label j. This particular belief propagation process may reduce the complexity of decoding because the plurality of inferred labels can be determined without performing an exhaustive search. Belief propagation processes may be particularly suitable when a sparse code is used for encoding, since the belief propagation process converges more quickly for sparse codes.

Whilst this example of a belief propagation algorithm uses the union, intersection and difference set operations, any suitable set operations may, in general, be used to decode the plurality of outputs. Thus, for example, the one or more set operations may comprise one or more of: union, intersection, complement and difference.

The present disclosure thus provides methods for decoding a plurality of outputs from a distributed inference process.

As noted above, a distributed inference process may be representative of both a regression process and a classification process. In some examples, the distribution inference process may comprise identifying an aspect in an image using a regression process and classifying the identified aspect using a classification process. For example, the distributed inference process may be used to return the coordinates of an object in an image and identify the object as a person.

In embodiments in which the distributed inference process comprises regression and classification, redundancy may be provided for both regression and classification. As such, as described above, the plurality of outputs may comprise a plurality of results, one or more redundant results, a plurality of labels and one or more redundant labels. According to aspects of the present disclosure, the plurality of outputs may be jointly decoded to obtain the inference data.

This may be illustrated by considering an example of a distributed inference process which comprises performing object detection on images. In this example, the coded inference process for each respective input may return:
objectᵢ={bounding boxᵢ,classᵢ},

in which bounding box; indicates the position and dimensions of a bounding box for an objectᵢ detected in a respective image, and classᵢ indicates a class or category assigned to the objectᵢ. Thus, for example, each instance of the coded inference process may return an output [x, y, w, h, p], in which [x,y] is the position of the bounding box, [w, h] are the width and height of the bounding box, and p is a vector indicating the probability (e.g., likelihood) the detected object being in one or more respective of each classes.

According to the present disclosure the outputs [x, y, w, h, p] from each of the component inference processes can be jointly decoded. Thus, for example, information gained whilst decoding the regression results may feed into decoding the classification results and vice versa. As such, at least one of the plurality of results and one of the redundant results may be decoded based on information obtained during decoding of at least one of the plurality of labels and one of the redundant labels. Similarly, at least one of the plurality of labels and one of the redundant labels may be decoded based on information obtained during decoding of at least one of the plurality of results and one of the redundant results. By jointly executing the bounding box recovery and class recovery procedures, missing inference data can be recovered.

An initial estimate of the class for a detected object can be obtained by using a belief propagation process, such as the belief propagation process described above. Alternatively, a detected object may be assigned the class that is associated with the highest probability (e.g., the highest p), or any class with a probability exceeding a threshold value.

It may then be determined whether objects detected in an image and a redundant image are the same object. This may be determined using, for example, intersection over union. According to this approach, if the class assigned to a first object A is the same as the class assigned to a second object B, and the intersection over union of A and B is larger than a threshold value, then A and B may be determined to be the same object. If both of these criteria are not satisfied, then A and B may be determined to be two separate objects. This procedure can be used to remove duplicate detected objects.

For bounding box recovery, one or more linear operations may be performed on the coordinates and sizes of the bounding boxes determined based on input images and one or more redundant images. Thus, for example, the coordinates [x,y] and the size [w,h] of a bounding box may be determined according to

$$[ x , y , w , h ] = \frac{1}{α} [ {x}^{′} - {x}_{Δ} , {y}^{′} - {y}_{Δ} , {w}^{′} , {h}^{′} ]$$

in which x_{Δ}, y_{Δ} are the offset of a detected object's positions between an input image and a redundant image, [x′, y′] and [w′, h′] are the coordinates and size of the bounding box in the redundant mage, and α is the scale factor of the size of the object between the input image and the redundant image. α may thus indicate how much the redundant image was downscaled for input to the component inference process, for example.

By jointly executing the bounding box recovery and class recovery procedures, missing inference data can be recovered, and the accuracy of the distributed inference process can be improved.

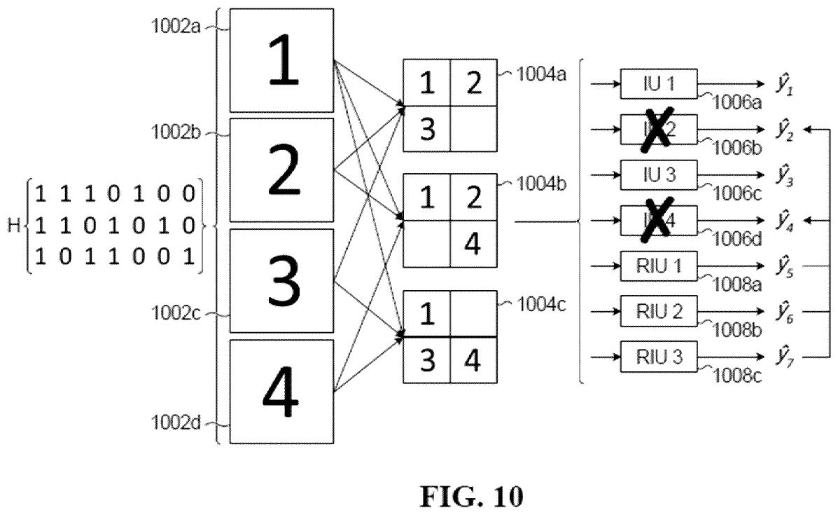

FIG. 10 shows an example of a distributed inference process according to embodiments of the disclosure. In this example, the distributed inference process is for detecting numbers in input images. Each of the input images has the same dimensions (N, M, P), in which N is a width of the image, M is the height of the image, and P is a number of bits per pixel.

The inputs 1002a, 1002b, 1002c, 1002d (collectively 1002) to the distributed inference process are encoded to obtain three redundant inputs 1004a, 1004b, 1004c (collectively 10004). This encoding may be performed in accordance with step 704 described above in respect of FIG. 7, for example. The inputs are encoding according to a code with parity check matrix:

$$H = ( \begin{matrix}1 & 1 & 1 & 0 & 1 & 0 & 0 \\ 1 & 1 & 0 & 1 & 0 & 1 & 0 \\ 1 & 0 & 1 & 1 & 0 & 0 & 1\end{matrix} )$$

Thus, the first redundant input 1004a comprises the first input 1002a, the second input 1002b and the third input 1002c. The second redundant input 1004b comprises the first input 1002a, the second input 1002b and the fourth input 1002d. The third redundant input 1004c comprises the first input 1002a, the third input 1002c and the fourth input 1002d.

Each of the redundant inputs 1004 is generated by tiling the respective inputs from the plurality of inputs 1004. The tiled inputs are padded and scaled such that each of the redundant inputs 1004 has the same dimensions as the inputs 1002. Thus, padding bits are added to the tiled inputs to form redundant inputs 1004 having the same shape as the inputs 1002. The redundant inputs 1004 are then downsampled to have the same size as the inputs 1002 (e.g., to have dimensions (N, M, P)).

Each of the inputs 1002 is transmitted to a respective one of the inference units 1006a, 1006b, 1006c, 1006d (collectively 1006) for a component inference process. Thus, the first input 1002a may be sent to the first inference unit 1006a, for example.

Each of the redundant inputs 1004 is sent to a respective one of the redundant inference units 1008a, 1008b, 1008c (collectively 1008) for the component inference process. Thus, the first redundant input 1004a may be sent to the first redundant inference unit 1008a, for example.

Each of the inference units 1006 and the redundant inference units 1008 implements the same component inference process as part of the distributed inference process. Thus, for example, each of the inference units 1006 and the redundant inference units 1008 may execute the same code to detect numbers in their respective input. The inference units 1006 and the redundant inference units 1008 may operate in the same manner as the processing apparatus described above in respect of FIG. 7, for example.

Each of the inference units 1006 and the redundant inference units 1008 is configured to provide a respective output y from the component inference process. In this example, the respective outputs comprise labels indicating numbers detected in the input images 1002 and the redundant images 1004. Thus, the first, second, third and fourth inference units 1006a, 1006b, 1006c, 1006d are operable to perform the component inference process using the respective first, second, third and fourth inputs 1002a, 1002b, 1002c, 1002d to obtain respective labels ŷ₁, ŷ₂, ŷ₃, ŷ₄. The first, second, and third redundant inference units 1008a, 1008b, 1008c are operable to perform the component inference process using the respective first, second and third redundant inputs 1004a, 1004b and 1004c to obtain respective labels ŷ₅, ŷ₆, ŷ₇.

However, as illustrated, the second inference unit 1006b and the fourth inference unit 1006b fail to return their respective labels ŷ₂, ŷ₄. There are various reasons why this may occur. For example, there may have been a communication failure when one or both of the second inference unit 1006b and the fourth inference unit 1006d attempted to transmit their respective results 92, 94. In another example, there may have been a computation error at one or both of the second inference unit 1006b and the fourth inference unit 1006d when performing the component inference process.

The missing labels ŷ₂, ŷ₄ are recovered by decoding the labels that were received from the inference units 1006 and the redundant inference units 1008. Since the second input 1002 (e.g., the input to the second inference unit 1006b) was comprised in the first and second redundant inputs 1004a, 1004b, an estimate of the second label ŷ₂ is determined based on the labels ŷ₅, ŷ₆ from the first and second redundant inference units 1008a, 1008b. The estimate of the second label ŷ₂ may be further determined based on at least one of: the label ŷ₇ from the third redundant inference unit 1008c and the labels ŷ₁, ŷ₃ from the first and third inference units 1006a, 1006c.

Since the fourth input 1004 (e.g., the input to the fourth inference unit 1006d) was comprised in the second and third redundant inputs 1004b, 1004c, an estimate of the fourth label ŷ₄ is determined based on the labels ŷ₆, ŷ₇ from the first and second redundant inference units 1008b, 1008c. The estimate of the fourth label 94 may be further determined based on at least one of: the label ŷ₂ from the first redundant inference unit 1008a and the labels ŷ₁, ŷ₃ from the first and third inference units 1006a, 1006c.

Thus, even though the second and fourth inference units 1006a, 1006c failed to return their respective labels 92, 94, these missing labels can be recovered from the labels that were returned by the distributed inference process. The decoding may be performed in accordance with step 804 described above in respect of FIG. 8, for example. Thus, one or more set operations may be used to recover the missing labels 92, 94. For example, the belief propagation process described above in respect of step 804 of the method 800 may be used to recover the missing labels ŷ₂, ŷ₄.

Although the example illustrated in FIG. 10 is described in the context of number recognition, the skilled person will appreciate that the described aspects are applicable to inference processes more generally. Thus, aspects of the example described in respect of FIG. 10 may be applied to, for example, distributed inference processes representative of machine learning classification processes and even to, more generally, distributed inference processes representative of machine learning processes.

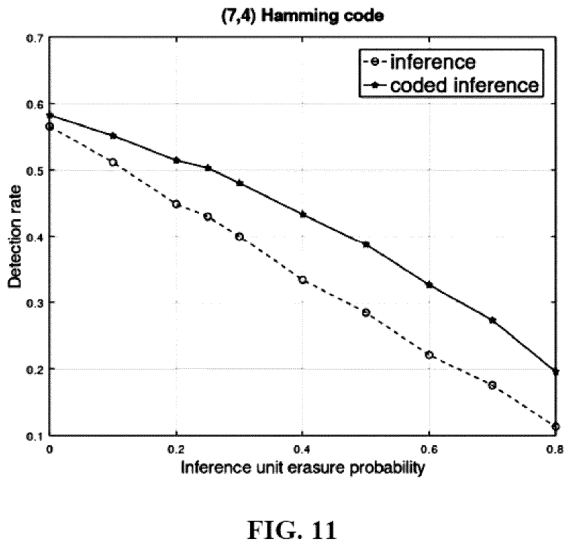

FIG. 11 shows the detection rate for object detection processes performed on images according to embodiments of the disclosure. Inference was performed on images from the COCO-val2017 dataset (Lin, Tsung-Yi, et al. “Microsoft coco: Common objects in context.” European conference on computer vision. Springer, Cham, 2014) to detect 36781 labelled objects. The detection rate indicates the proportion of objects in the images that were correctly detected and labelled by the inference process.

In each example shown in FIG. 11, a YOLOv3 model (Farhadi, Ali, and Joseph Redmon. “Yolov3: An incremental improvement.” Computer Vision and Pattern Recognition. Berlin/Heidelberg, Germany: Springer, 2018) was trained using the COCO-train2017 dataset (Lin, Tsung-Yi, et al. “Microsoft coco: Common objects in context.” European conference on computer vision. Springer, Cham, 2014).

The lower dashed line shows the detection rate for an inference process performed without any redundancy (e.g., without encoding as described herein). The upper solid line shows the detection rate for object detection performed by a distributed inference process according to embodiments of the disclosure (e.g., in which encoding was performed according to the method 700 and decoding was performed according to the joint decoding process described above). In this example, images in the COCO-train2017 dataset were grouped into batches of four images, and three redundant images were generated for each batch using a (7, 4) Hamming code with a parity check matrix

$$H = ( \begin{matrix}1 & 1 & 1 & 0 & 1 & 0 & 0 \\ 1 & 1 & 0 & 1 & 0 & 1 & 0 \\ 1 & 0 & 1 & 1 & 0 & 0 & 1\end{matrix} )$$

Thus, a (7, 4) Hamming code was used to generate 7 inputs comprising 4 input images and 3 redundant input images. The generator matrix for this Hamming code may be expressed as

$$G = ( \begin{matrix}1 & 0 & 0 & 0 & 1 & 1 & 1 \\ 0 & 1 & 0 & 0 & 1 & 1 & 0 \\ 0 & 0 & 1 & 0 & 1 & 0 & 1 \\ 0 & 0 & 0 & 1 & 0 & 1 & 1\end{matrix} )$$

Each of the input images and redundant input images were input to a respective instance of the trained YOLOv3 model, which output bounding box estimates and class predictions for one or more objects detected in the image. These outputs were decoded in accordance with the joint decoding process and belief propagation process described above.

This process was repeated at erasure probabilities ranging from 0 to 0.8, in which the erasure probability indicates the likelihood of each instance of the YOLOv3 model returning its respective output. Thus, for example, an erasure probability of o indicates that all of the outputs of the YOLOv3 models were returned. As shown in FIG. 11, the distributed inference process that implements aspects of the present disclosure provides a higher object detection rate at all of the tested erasure probabilities, including zero. In the context of image detection, aspects of the present disclosure thus provide improved object detection rates.

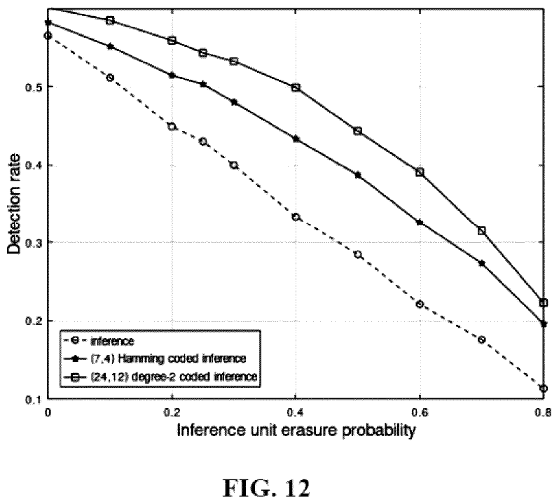

FIG. 12 shows the object detection rate for the inference process performed without any redundancy (e.g., without encoding as described herein) compared to the object detection rate for the inference process described herein implemented with different codes. The lower dashed line (with circular markers) shows the object detection rate for the inference process performed without any redundancy. The object detection rates for an implementation with a (7,4) Hamming code as described above in respect of FIG. 11 is shown by the middle solid line with asterisk markers. The upper solid line with square markers shows the object detection rate for an implementation using a (24, 12) code with degree-2. For the (24,12) code, the images were grouped into batches of 12 images, and 12 redundant images were generated for each batch such that 24 images were input to instances of YOLOv3 for each batch. As the (24,12) code is degree-2, each redundant image contained data from two images. The parity matrix for the (24,12) degree-2 code may be expressed as:

$$H = ( \begin{matrix}1 & 1 & 0 & 0 & 0 & 0 & 0 & 0 & 0 & 0 & 0 & 0 & 1 & 0 & 0 & 0 & 0 & 0 & 0 & 0 & 0 & 0 & 0 & 0 \\ 0 & 0 & 1 & 1 & 0 & 0 & 0 & 0 & 0 & 0 & 0 & 0 & 0 & 1 & 0 & 0 & 0 & 0 & 0 & 0 & 0 & 0 & 0 & 0 \\ 0 & 0 & 0 & 0 & 1 & 1 & 0 & 0 & 0 & 0 & 0 & 0 & 0 & 0 & 1 & 0 & 0 & 0 & 0 & 0 & 0 & 0 & 0 & 0 \\ 0 & 0 & 0 & 0 & 0 & 0 & 1 & 1 & 0 & 0 & 0 & 0 & 0 & 0 & 0 & 1 & 0 & 0 & 0 & 0 & 0 & 0 & 0 & 0 \\ 0 & 0 & 0 & 0 & 0 & 0 & 0 & 0 & 1 & 1 & 0 & 0 & 0 & 0 & 0 & 0 & 1 & 0 & 0 & 0 & 0 & 0 & 0 & 0 \\ 0 & 0 & 0 & 0 & 0 & 0 & 0 & 0 & 0 & 0 & 1 & 1 & 0 & 0 & 0 & 0 & 0 & 1 & 0 & 0 & 0 & 0 & 0 & 0 \\ 0 & 1 & 1 & 0 & 0 & 0 & 0 & 0 & 0 & 0 & 0 & 0 & 0 & 0 & 0 & 0 & 0 & 0 & 1 & 0 & 0 & 0 & 0 & 0 \\ 0 & 0 & 0 & 1 & 1 & 0 & 0 & 0 & 0 & 0 & 0 & 0 & 0 & 0 & 0 & 0 & 0 & 0 & 0 & 1 & 0 & 0 & 0 & 0 \\ 0 & 0 & 0 & 0 & 0 & 1 & 1 & 0 & 0 & 0 & 0 & 0 & 0 & 0 & 0 & 0 & 0 & 0 & 0 & 0 & 1 & 0 & 0 & 0 \\ 0 & 0 & 0 & 0 & 0 & 0 & 0 & 1 & 1 & 0 & 0 & 0 & 0 & 0 & 0 & 0 & 0 & 0 & 0 & 0 & 0 & 1 & 0 & 0 \\ 0 & 0 & 0 & 0 & 0 & 0 & 0 & 0 & 0 & 1 & 1 & 0 & 0 & 0 & 0 & 0 & 0 & 0 & 0 & 0 & 0 & 0 & 1 & 0 \\ 1 & 0 & 0 & 0 & 0 & 0 & 0 & 0 & 0 & 0 & 0 & 1 & 0 & 0 & 0 & 0 & 0 & 0 & 0 & 0 & 0 & 0 & 0 & 1\end{matrix} )$$

As shown in FIG. 12, each of the distributed inference processes encoded and decoded according to aspects of the disclosure provides a detection rate that exceeds the detection rate of the inference process with no redundancy. Moreover, FIG. 12 shows that the highest detection rate is provided by a degree-2 code, indicating that performance can be optimized by selecting the code according to one or more rules as described above in respect of FIG. 2.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the figures or all of the portions schematically shown in the figures. Moreover, selected features of one example embodiment may be combined with selected features of other example embodiments.

While this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

What is claimed:

1. A method comprising:
obtaining a plurality of inputs for a distributed inference process representative of a machine learning process, each input of the plurality of inputs being for a same component inference process of the distributed inference process;
encoding the plurality of inputs to generate one or more redundant inputs such that each redundant input of the one or more redundant inputs comprises a concatenation of data from respective at least two inputs of the plurality of inputs, each redundant input of the one or more redundant inputs being for the same component inference process of the distributed inference process; and
transmitting, for each input of the plurality of the inputs and each redundant input of the one or more redundant inputs, a respective input of the plurality of the inputs and the one or more redundant inputs to a respective processing apparatus for performing the same component inference process as part of the distributed inference process.

2. The method of claim 1, wherein the transmitting the respective input to the respective processing apparatus comprises:
transmitting the respective input to the respective processing apparatus over a wireless communication link.

3. The method of claim 1, further comprising:
for each redundant input of the one or more redundant inputs, resizing a respective redundant input such that the respective redundant input has a same dimension as at least one input of the plurality of inputs.

4. The method of claim 3, wherein the resizing comprises at least one of:
cropping, downsampling, interpolation or padding the respective redundant input.

5. The method of claim 1, wherein the plurality of inputs form an ordered dataset, and wherein, for each redundant input of the one or more redundant inputs, the respective at least two inputs of the plurality of inputs are adjacent in the ordered dataset.

6. The method of claim 1, wherein the machine learning process comprises a deep neural network.

7. A method comprising:
obtaining a plurality of outputs of a distributed inference process representative of a machine learning regression process, the plurality of outputs comprising a plurality of results and one or more redundant results, wherein:
each result of the plurality of results is determined by a same component inference process of the distributed inference process based on a respective input in a plurality of inputs, and
each redundant output of the one or more redundant outputs is determined by the same component inference process of the distributed inference process based on a respective redundant input comprising a concatenation of data from respective at least two inputs of the plurality of inputs; and
performing one or more linear operations on at least two results to decode the plurality of outputs to obtain inference data, wherein the at least two results are from the plurality of results and the one or more redundant results, and the at least two results comprise at least one redundant result of the one or more redundant results.

8. The method of claim 7, wherein the performing the one or more linear operations to decode the plurality of outputs to obtain the inference data comprises:
performing the one or more linear operations to determine a missing output from the distributed inference process.

9. The method of claim 7, wherein the distributed inference process is further representative of a machine learning classification process, the plurality of outputs further comprising a plurality of labels and one or more redundant labels, and wherein the method further comprises:
performing one or more set operations on at least two labels to decode the plurality of outputs to obtain the inference data, wherein the at least two labels are from the plurality of labels and the one or more redundant labels, and the at least two labels comprise at least one redundant label of the one or more redundant labels.

10. A method comprising:
obtaining a plurality of outputs from a distributed inference process representative of machine learning classification process, the plurality of outputs comprising a plurality of labels and one or more redundant labels, wherein:
each label of the plurality of labels is determined by a same component inference process of the distributed inference process based on a respective input in a plurality of inputs, and
each redundant label of the one or more redundant labels is determined by the same component inference process of the distributed inference process based on a respective redundant input comprising a concatenation of data from respective at least two inputs of the plurality of inputs; and
performing one or more set operations on at least two labels to decode the plurality of outputs to obtain inference data, wherein the at least two labels are from the plurality of labels and the one or more redundant labels, and the at least two labels comprise at least one redundant label of the one or more redundant labels.

11. The method of claim 10, wherein the performing the one or more set operations to decode the plurality of outputs to obtain the inference data comprises:
performing the one or more set operations to determine a missing label from the distributed inference process.

12. The method of claim 10, wherein the distributed inference process is further representative of a machine learning regression process, the plurality of outputs further comprising a plurality of results and one or more redundant results, and wherein the method further comprises:
performing one or more linear operations on at least two results to decode the plurality of outputs to obtain the inference data, wherein the at least two results are from the plurality of results and the one or more redundant results, and the at least two results comprise at least one redundant result of the one or more redundant results.

13. The method of claim 10, wherein the performing the one or more set operations to decode the plurality of outputs to obtain the inference data comprises:
performing a belief propagation process to decode the plurality of outputs to obtain the inference data.

14. An apparatus comprising:
a memory storing instructions;
at least one processor caused, by executing the instructions, to perform operations including:
obtaining a plurality of inputs for a distributed inference process representative of a machine learning process, each input of the plurality of inputs being for a same component inference process of the distributed inference process;
encoding the plurality of inputs to generate one or more redundant inputs such that each redundant input of the one or more redundant inputs comprises a concatenation of data from a respective at least two inputs of the plurality of inputs, each of the one or more redundant inputs for the same component inference process of the distributed inference process; and
transmitting, for each input of the plurality of the inputs and each redundant input of the one or more redundant inputs, a respective input of the plurality of the inputs and the one or more redundant inputs to a respective processing apparatus for performing the same component inference process as part of the distributed inference process.

15. The apparatus of claim 14, wherein the transmitting the respective input to the respective processing apparatus comprises:
transmitting the respective input to the respective processing apparatus over a wireless communication link.

16. The apparatus of claim 14, the operations further comprising:
for each redundant input of the one or more redundant inputs, resizing a respective redundant input such that the respective redundant input has a same dimension as at least one input of the plurality of inputs.

17. The apparatus of claim 16, wherein the resizing comprises at least one of:
cropping, downsampling, interpolation or padding the respective redundant input.

18. The apparatus of claim 14, wherein the plurality of inputs form an ordered dataset, and wherein, for each redundant input of the one or more redundant inputs, the respective at least two inputs of the plurality of inputs are adjacent in the ordered dataset.

19. The apparatus of claim 14, wherein the machine learning process comprises a deep neural network.
